(19) United States
(12) Patent Application Publication
(10) Pub. No.: US 2013/0059394 A1
(43) Pub. Date: Mar. 7, 2013

(54) INDICATOR SYSTEM FOR FIBRE OPTIC SENSOR

(71) Applicants: Barry Colin Crane, Shennington (GB); Tony James, Radstock (GB); John Fossey, Birmingham (GB); Nicholas Paul Barwell, Whoberley (GB)

(72) Inventors: Barry Colin Crane, Shennington (GB); Tony James, Radstock (GB); John Fossey, Birmingham (GB); Nicholas Paul Barwell, Whoberley (GB)

(21) Appl. No.: 13/578,904

(22) PCT Filed: Feb. 15, 2011
(86) PCT No.: PCT/GB11/00207

§ 371 Date: Nov. 21, 2012

Related U.S. Application Data
(60) Provisional application No. 61/306,342, filed on Feb. 19, 2010.

(51) Int. Cl. G01N 21/64; B23P 11/00

(52) U.S. Cl. 436/95; 422/69; 29/428

(57) ABSTRACT

The invention provides an optical sensor, e.g a fibre optic sensor, for determining the presence or amount of an analyte in a medium, the sensor having an indicator provided in the form of a fluid. In one aspect, the sensor contains either a solution of the indicator itself, or a solution of a support material which is bonded to the indicator. Dendrimers are examples of suitable support materials.

The present invention relates to a fibre optic sensor containing an indicator in the form of a fluid. The invention also provides a kit comprising the sensor and a method of manufacturing the sensor.

### BACKGROUND TO THE INVENTION

Optical fibres have in recent years found use as chemical or biological sensors, in particular in the field of invasive or implantable sensor devices. Such optical fibre sensors typically involve an indicator, whose optical properties are altered in the presence of the analyte of interest. For example, fluorophores having a receptor capable of binding to the target analyte have been used as indicators in such sensors.

Attachment of the indicator to an optical fibre can be achieved by physically entrapping the indicator in a polymer matrix such as a hydrogel, which is coated onto the fibre. However, such physical entrapment may lead to leakage of the indicator and consequent loss of functionality of the sensor. To address the issue of leakage, indicators have been chemically bonded to the matrix by polymerising the indicator with a matrix-forming monomer. This leads to the immobilisation of the indicator onto a polymeric matrix and effective containment of the indicator within the sensor.

However, such fluorescent sensors, which are immobilised on a polymeric matrix, can have particular disadvantages. Fluorescent sensors can be dramatically influenced by their microenvironment. Polymers have heterogeneous structures and as such provide differing localised microenvironments for the fluorescent indicator. This leads to variation in the indicator response. In a measurement of the lifetime decay of the fluorescent indicator, the signal from an indicator immobilised onto a polymeric matrix may be a continuous distribution of decay times and complex multi exponentials, rather than the desired single, simple exponential. In a measurement of the intensity of the fluorescent indicator, the signal intensity and modulation may be affected by the binding of the indicator to the polymeric support. Decreased modulation, i.e. the amount of increase in signal which is seen relative to the amount of analyte, is a particular problem. It is therefore desired to provide a sensor having improved modulation and greater consistency in the sensor response.

### SUMMARY OF THE INVENTION

The present invention provides an optical sensor for determining the amount or presence of an analyte in a medium, the sensor comprising a cell comprising (a) an indicator for the analyte or (b) a supported indicator comprising an indicator for the analyte bonded to a support material, wherein the indicator or supported indicator is in fluid form, and wherein the cell comprises one or more openings covered with an analyte-permeable membrane, the membrane being adapted to retain the indicator or supported indicator within the cell.

The sensor of the invention thus contains the indicator in fluid form. Typically, the indicator, or supported indicator, is in solution, for in vitro uses this will be aqueous solution. In one embodiment, the indicator itself is dissolved in the solution. In an alternative embodiment, the indicator is bonded to a soluble support material, typically a high molecular weight macromolecule such as a polymer or dendrimer, and the supported indicator (support material having indicator bonded thereto) is dissolved in the solution.

In an alternative embodiment, the indicator is bound to a high water content hydrogel as the support material. The water content of the hydrogel is such that it is considered to be a fluid. When mixed with water or aqueous solution, a mixture of fluids is formed with no boundaries between polymeric and aqueous domains.

In the case of indicators which are physically entrapped or chemically bonded into a polymer matrix in the sensor, the indicator is located in a substantially fixed position within the polymer matrix structure. Movement of the indicator is thus restricted. In the present invention, however, the indicator is free to move within the fluid present in the cell. This is understood to facilitate analyte binding and to improve the modulation of the sensor. The effect is particularly beneficial when a solution of indicator or supported indicator is used.

Furthermore, when the indicator is dissolved in a solvent, such as water, particularly at low concentrations such that the indicator molecules do not aggregate and are monodispersed, homogeneity is maximum and ideal fluorescent characteristics are achieved for that given solvent. This leads to a signal which is a single exponential in a lifetime decay measurement and consistency in signal intensity and modulation for an intensity measurement.

An alternative means to achieve homogeneity is to immobilise the indicator onto a single molecule support of large molecular weight. Preferably the support is symmetrical and the spatial attachment of the fluorescent indicator is achieved in such a way that the result is also symmetrical. Thus the environments of each fluorescent indicator molecule attached to such a support will be equivalent. In addition if such a supported molecule can be dissolved in a solvent, such as water, at an appropriate concentration, the environments of the supported indicator will be homogenous, again leading to improved signal characteristics.

In the case that the indicator is bound to a polymeric support, such a support is preferably provided in solution form, or at least in the form of a mixture of fluids, so that there are no solid interfaces between aqueous and polymeric domains. This provides more consistency in the microenvironment of the indicator and thus improved signal characteristics.

Another advantage of using a large molecular weight support for the indicator, or a large molecular weight indicator alone, is that it can be contained within a membrane that is substantially impermeable to the indicator or supported indicator but permeable to the analyte to be detected, thus facilitating detection. This enables the analyte to enter the cell through the one or more openings, but prevents or restricts loss of the indicator.

A particular embodiment of the invention relates to the use of a dendrimer as a support material. This has particular advantages because a dendrimer has a uniform structure, i.e. it is monodisperse. Further, a symmetrical structure can be obtained by binding an indicator to each functional group on the surface of a dendrimer. Such monodispersity and symmetry provide a highly uniform environment for binding the analyte. This leads to a more consistent fluorophore response to analyte binding and accordingly a more sensitive sensor.

The present invention also provides a kit comprising a sensor according to the invention, apparatus adapted to supply incident light to the optical waveguide, and a detector for detecting a returned signal. Also provided is a method of manufacturing a sensor of the invention, comprising providing a cell having one or more openings, inserting into the cell (a) an indicator or (b) a supported indicator comprising an indicator bonded to a support material, wherein the indicator or supported indicator is in fluid form, and covering one or more openings of the cell with an analyte-permeable membrane, the membrane being adapted to retain the indicator or supported indicator within the cell.

Also provided is a method of determining the presence or concentration of an analyte in a medium, the method comprising providing incident light to the cell of an optical sensor of the invention and detecting a return optical signal. The method may be used to measure fluorescence intensity and/or fluorescence lifetime where the indicator comprises a fluorophore.

### BRIEF DESCRIPTION OF THE FIGURES

FIGS. 1 and 1a depict a sensor kit of the invention.

FIG. 2 depicts the sensing region of a sensor of the invention in more detail.

FIG. 3 depicts generation 1 or generation 2 dendrimers with di-boronic acid receptors appended.

### DETAILED DESCRIPTION OF THE INVENTION

As used herein the term alkyl or alkylene is a linear or branched alkyl group or moiety. An alkylene moiety may, for example, contain from 1 to 15 carbon atoms such as a C₁₋₁₂ alkylene moiety, C₁₋₆ alkylene moiety or a C₁₋₄ alkylene moiety, e.g. methylene, ethylene, n-propylene, i-propylene, n-butylene, i-butylene and t-butylene. C₁₋₄ alkyl is typically methyl, ethyl, n-propyl, i-propyl, n-butyl or t-butyl. For the avoidance of doubt, where two alkyl groups or alkylene moieties are present, the alkyl groups or alkylene moieties may be the same or different.

An alkyl group or alkylene moiety may be unsubstituted or substituted, for example it may carry one, two or three substituents selected from halogen, hydroxyl, amine, (C₁₋₄ alkyl)amine, di(C₁₋₄ alkyl)amine and C₁₋₄ alkoxy. Preferably an alkyl group or alkylene moiety is unsubstituted.

As used herein the term aryl or arylene refers to C₆₋₁₄ aryl groups or moieties which may be mono- or polycyclic, such as phenyl, naphthyl and fluorenyl, preferably phenyl. An aryl group may be unsubstituted or substituted at any position. Typically, it carries 0, 1, 2 or 3 substituents. Preferred substituents on an aryl group include halogen, C₁₋₁₅ alkyl, C₂₋₁₅ alkenyl, —C(O)R wherein R is hydrogen or C₁₋₁₅ alkyl, —CO₂R wherein R is hydrogen or C₁₋₁₅ alkyl, hydroxy, C₁₋₁₅ alkoxy, and wherein the substituents are themselves unsubstituted.

As used herein, a heteroaryl group is typically a 5- to 14-membered aromatic ring, such as a 5- to 10-membered ring, more preferably a 5- or 6-membered ring, containing at least one heteroatom, for example 1, 2 or 3 heteroatoms, selected from O, S and N. Examples include thiophenyl, furanyl, pyrrolyl and pyridyl. A heteroaryl group may be unsubstituted or substituted at any position. Unless otherwise stated, it carries 0, 1, 2 or 3 substituents. Preferred substituents on a heteroaryl group include those listed above in relation to aryl groups.

As used herein, an indicator or supported indicator in fluid form encompasses liquids or solutions which comprise the indicator or supported indicator. The indicator is therefore not tethered to a solid support matrix. The fluid may be a solution in which the indicator or supported indicator is dissolved. Aqueous solutions are preferred. Alternatively, it may be a hydrogel-bound indicator having a water content sufficiently high to render the hydrogel a fluid. Typically, a hydrogel having a water content of at least 30% w/w will be considered a fluid within the context of the present invention. The solution or fluid comprising the indicator or supported indicator may be mixed with further fluids, e.g. with water or an aqueous solution.

The present invention is envisaged for use with any sensor involving an optical waveguide, e.g. a fibre optic sensor. Sensors, e.g invasive sensors, for in vivo use are particularly envisaged, but the present invention is not limited to such sensors.

Examples of analytes that can be detected by use of a sensor of the invention include potassium, sugars, e.g. glucose and other biological or non-biological substances which are currently detected by use of fibre optic devices.

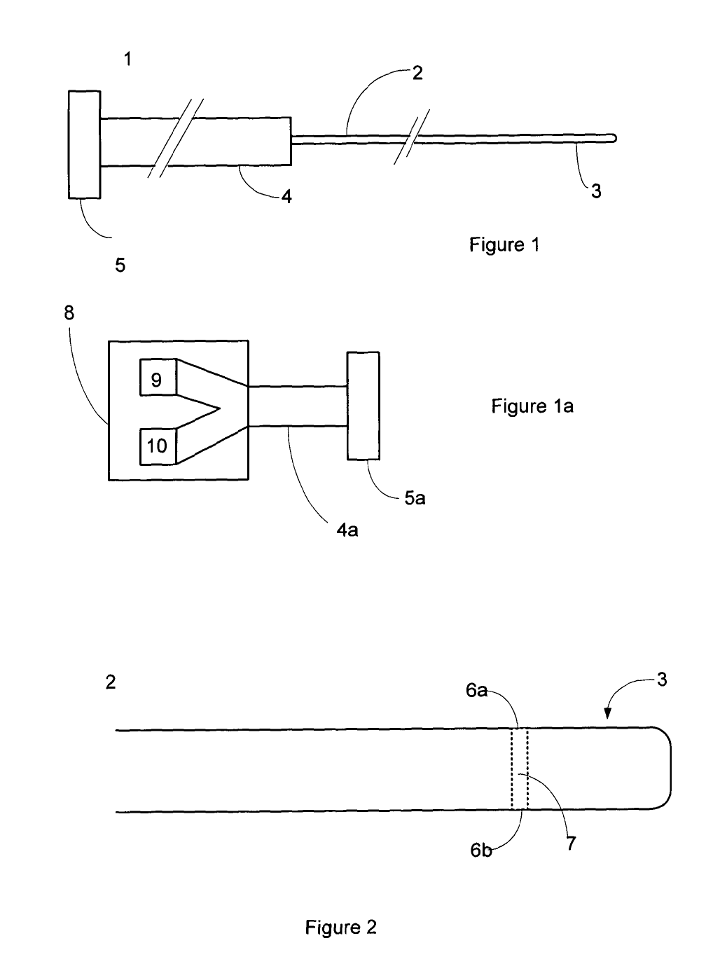

An example of an optical fibre sensor according to the invention is depicted in FIG. 1. The sensor 1 comprises a tip 2 including a sensing region 3 which is adapted for insertion into the medium under test. In the case of an invasive sensor, tip 2 is adapted for insertion into a patient, for example insertion into a blood vessel through a cannula. The sensing region 3 (depicted in more detail in FIG. 2) contains a cell or chamber 7 in which the indicator is contained. The optical fibre extends through cable 4 to connector 5, which is adapted to mate with an appropriate monitor 8. The monitor typically includes further optical cable 4a that mates with the connector at one end 5a and at the other bifurcates to connect to (a) an appropriate source of incident light for the optical sensor 9 and (b) a detector for the returned signal 10. The sensor may measure the fluorescence intensity of the fluorophore, or alternatively the fluorescence lifetime may be measured.

The sensor here depicted comprises an optical fibre waveguide to direct incident light to the cell. The present invention is not limited to optical fibre sensors and other optical waveguides are also envisaged.

The cell 7 as here depicted is in the form of a chamber within the sensing region of the fibre. The cell may take any form, as long as it enables the indicator to be contained in the path of the incident light. Thus, the cell may be attached to the distal end of the fibre or other waveguide or may be in the form of a chamber within the fibre having any desired shape.

The cell comprises one or more openings 6a, 6b which enable analyte to diffuse into the cell from the surrounding environment during use. Since the indicator is provided in fluid form, a membrane must be provided to cover each of the openings of the cell and to keep the indicator within the sensor. The membrane is capable of allowing analyte to pass through from the external environment into the cell. However, the membrane is preferably impermeable, or substantially impermeable, to the indicator or, where provided on a support material, to the supported indicator. This ensures that the indicator is restricted from leaking out of the cell.

The choice of membrane pore size is accordingly dependent on the molecular weight of the analyte, and that of the indicator, or of the supported indicator. The pore size must be sufficient to allow analyte to pass through. However, it should as far as possible restrict the movement of the indicator or supported indicator. Ideally, the membrane should have a molecular weight cut off which is at least 4 times, preferably at least 5 times greater than the molecular weight of the analyte. This helps to enable the analyte to move rapidly through the membrane. The molecular weight cut off is preferably at least 3 times, more preferably at least 4 or at least 5 times smaller than the molecular weight of the indicator or supported indicator. This helps to restrict leakage of the indicator or supported indicator.

For example, in the case of a glucose sensor (glucose molecular weight=180), a membrane having a molecular weight cut-off of at least about 500, preferably at least about 800 or at least about 1000, is used. In the case of a membrane having a molecular weight cut-off of about 500, it is preferred that the indicator, or supported indicator, has a molecular weight of at least 1500, for example at least 2000 or at least 2500.

Suitable membranes include polyarylethersulphone, polyamide, polycarbonate, polyacrylonitrile, polysulphone, polyethersulphone, polyalkanes and cellulosic materials or mixtures or modifications thereof. Dialysis membranes, e.g. cellulose membranes, are appropriate for use with glucose sensors. In a preferred embodiment, the membrane for a glucose sensor is provided by a semi-permeable membrane, typically a dialysis membrane, having a pore size which ensures permeability to glucose but which restricts or prevents the passage of larger macromolecules such as proteins and glycated proteins into the cell. Typically, the membrane will restrict the passage of molecules having a molecular weight of 6000 or greater, preferably molecules having a molecular weight of 5000 or 4000 or greater. Use of a dialysis membrane having a molecular weight cut off of from 1000 to 5000, e.g. 1500 to 4000 is particularly useful. Preferred pore sizes are 3 to 20 nm, preferably 3 to 10 nm, for example about 6 nm.

In a particular embodiment, a hydrophilic and/or negatively charged polymer is present within the pores of the membrane. This is typically achieved via in situ polymerisation, within the pores of the membrane, of a monomer mixture comprising one or more hydrophilic monomers and/or one or more negatively charged monomers. The resulting membrane is particularly effective as a barrier to proteins and glycated proteins due to its hydrophilicity and/or negative charge and has the further advantage that the polymerisation process may be used to control, and to further decrease, the pore size of the membrane.

The provision of the polymer within the pores of the membrane is typically achieved by diffusing one or more suitable hydrophilic and/or negatively charged monomers into the membrane (typical pore size 6 to 20 nm) and initiating polymerisation, for example by applying UV activation in the presence of an initiator. This leads to polymerisation occurring within the pores of the membrane and the resulting polymer is trapped within the pores. If desired, the diffusion and polymerisation steps can be repeated one or more times to increase the amount of polymer formed within the membrane pores.

Preferably, the hydrophilic functional group integrated into the dialysis membrane is polyethylene glycol or polyethylene oxide which have known protein repelling characteristics. Suitable hydrophilic monomers for use in this embodiment therefore include polyethyleneglycol dimethacrylate, polyethyleneglycol dimethacrylamide, polyethylenglycol diacrylate and polyethyleneglycol diacrylamide, or a combination thereof. Polyethyleneglycol dimethacrylate is preferred. Polyethylene glycol dimethacrylate and polyethyleneglycol diacrylate, and various derivatives, of varying molecular weights can be readily obtained from Sigma-Aldrich, UK.

Suitable negatively charged monomers include potassium sulphopropylmethacrylate, acrylic or methacylic acids or combinations thereof.

Typically, the polymerisation mixture which is diffused into the membrane pores comprises a chain extending monomer in addition to the hydrophilic monomer(s). Examples of suitable chain extenders include di(meth)acrylate and di(meth)acrylamide.

In an alternative embodiment, the membrane is produced by incorporating a hydrophilic and/or negatively charged polymer into the polymer mixture prior to wet spinning of a dialysis membrane. The resulting membrane accordingly comprises hydrophilic or negatively charged areas or pockets which allow water to pass through. The hydrophilicity or negative charge of the resulting membrane can be controlled by varying the amount of hydrophilic or negatively charged polymer which is incorporated. Typically, hydrophilic and/or negatively charged polymers make up about 10% of the total polymer content of the solution prior to spinning.

Examples of suitable hydrophilic polymers are polyethylene glycol, polyethylene oxide and polyvinylpyrrolidone. Examples of suitable negatively charged polymers are the polymers derived from potassium sulphopropylmethacrylate, acrylic and methacylic acids.

Further details of suitable membranes for a glucose sensor can be found in the applicant's copending application ‘BARRIER LAYER FOR GLUCOSE SENSOR’, the contents of which are incorporated herein in their entirety.

The fluid provided within the cell is in one embodiment a solution, typically an aqueous solution. During use, the solvent will typically pass across the semi-permeable membrane into and out of the cell. It is therefore important that the solvent used be compatible with the environment under test. Preferably, the solvent used is the same as the solvent of the medium under test. In the case of invasive sensors, the solvent should be water.

An indicator as used herein is a compound whose optical properties are altered on binding with an analyte. Typically, an indicator includes a receptor, which is a moiety which selectively binds to the analyte, and a fluorophore. The emission pattern (e.g. the wavelength, intensity or both) of the fluorophore is altered when the analyte is bound to the receptor allowing optical detection of the analyte. The receptor and fluorophore may be directly bonded to one another as a receptor-fluorophore construct. Alternatively, where a support material is present, the receptor and fluorophore may be separately bonded to the support material, such that the receptor and fluorophore are connected only via the support material.

Examples of suitable fluorophores include anthracene, pyrene and derivatives thereof. Examples of suitable receptors include compounds or moieties containing one or more boronic acid groups (selective for sugars), crown ethers (selective for potassium) and enzymes. Enzymes typically have a high molecular weight and can be used alone, without a support material.

In one embodiment of the invention, the receptor is selective for a sugar, e.g. glucose. Examples of suitable receptors are compounds having at least one, preferably two, boronic acid groups. In a preferred aspect of this embodiment, the receptor is a group of formula (I) or (II) below:

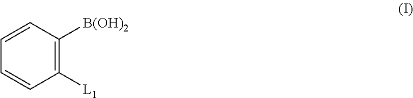

wherein L1 represents a linker group such as an alkylene moiety, e.g. a C₁-C₁₂ alkylene moiety or a C₁-C₆ alkylene moiety. L1 further forms the point of attachment to the fluorophore and/or the support material. For example, L1 may be bound to an amine or ester group, which is further bonded to the fluorophore and/or the support material.

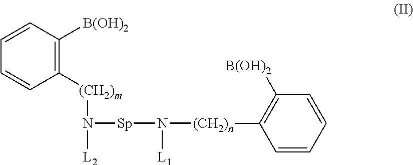

wherein m and n are the same or different and are typically one or two, preferably one; Sp is an alphatic spacer, typically an alkylene moiety, for example a C₁-C₁₂ alkylene moiety, e.g. a C6 alkylene moiety; and L1 and L2 represent possible points of attachment to other moieties, for example to a fluorophore or to a support material. For example, L1 and L2 may represent an alkylene, alkylene-arylene or alkylene-arylene-alkylene moiety, linked to one or more, typically one, functional group. Where no attachment to another moiety is envisaged, the functional group is protected or replaced by a hydrogen atom. Typical alkylene groups for L1 and L2 are C₁-C₄ alkylene groups, e.g. methylene and ethylene. Typical arylene groups are phenylene groups. The functional group may be any group which can react to form a bond with the fluorophore or support material e.g. ester, amide, aldehyde or azide.

Varying the length of the spacer Sp alters the selectivity of the receptor. Typically, a C6-alkylene chain provides a receptor which has good selectivity for glucose. Longer alkylene chains will lead to selectivity for larger sugars.

A particular advantage of the receptors of Formula (II) is the presence of two points of attachment to other moieties. Such receptors can therefore usefully provide a building block to create a fluorophore-receptor-support material construct. Further details of such receptors are found in U.S. Pat. No. 6,387,672, the contents of which are incorporated herein by reference in their entirety.

Receptors of formulae (I) and (II) can be prepared by known techniques. An exemplary synthesis is provided in Example 2 and further details can be found in U.S. Pat. No. 6,387,672.

In one embodiment of the invention, the indicator itself is dissolved in solution. This embodiment is typically employed when the indicator has a high molecular weight compared to the analyte. In this case, a semi-permeable membrane can be provided which enables analyte to pass through but which does not allow passage of the indicator.

In an alternative, preferred embodiment, the indicator is bonded to a support material (to provide a supported indicator) and this complex of support and indicator is dissolved in the solution or itself is in the form of a fluid. The nature of the complex is not important as long as the indicator remains bonded to the support. For example, the support material may be bonded to the indicator as a whole. Alternatively, the support material may be bonded separately to the fluorophore and to the receptor. In the latter case, the receptor and fluorophore are not directly bonded to one another but are linked only via the support material. In one embodiment of the invention, the complex takes the form fluorophore-receptor-support.

Typically, a high molecular weight support material is used. This enables the skilled person to restrict the passage of the indicator through the membrane by providing the indicator within a higher molecular weight complex. Preferred support materials have a molecular weight of at least 500, for example at least 1000, 1500 or 2000. The support material should also be soluble in the solvent used or itself be in the form of a fluid, and should be inert in the sense that it does not interfere with the sensor itself.

Suitable materials for use as the support material include polymers. Any non-cross-linked, linear polymer which is soluble in the solvent used can be employed. Alternatively, the support material may be a cross linked polymer (typically a lightly cross-linked polymer) that is capable of forming a hydrogel in water. For example, the support material may be a hydrogel formed from a lightly cross-linked polymer having a water content of at least 30% such that there is no distinct interface between the polymer and aqueous domains.

Polyacrylamide and polyvinylalcohol are examples of appropriate water-soluble, linear polymers. Preferably, the polymer used has a low polydispersity. More preferably, the polymers are uniform (or monodisperse) polymers. Such polymers are composed of molecules having a uniform molecular mass and constitution. The lower polydispersity leads to an improved sensor modulation. Cross-linked polymers for formation of hydrogels may be formed from the above water-soluble linear polymers cross-linked with ethylene glycol dimethacrylate and/or hydroxylethyldimethacrylate.

In one embodiment, the indicator is bound to a hydrogel having a high water content. In this instance, the sensor typically contains an aqueous solution containing the hydrogel. The water content of the hydrogel is so high, preferably at least 30% w/w, that the solution/hydrogel mixture can be considered a mixture of fluids with no distinct solid interfaces between the polymer and aqueous domains. As used herein, a hydrogel in the form of a fluid is a hydrogel having a water content which is so high (typically at least 30% w/w) that there are no distinct solid interfaces between the polymer and aqueous domains when the hydrogel is placed in water. Such a hydrogel may comprise a lightly cross-linked polymer which may dissolve in the solvent, or which may form a fluid hydrogel with a relatively low water content; alternatively, the hydrogel may comprise a more heavily cross-linked polymer having a higher water content such that it is in the form of a fluid.

In a particularly preferred embodiment, the support material is a dendrimer. The nature of the dendrimer for use in the invention is not particularly limited and a number of commercially available dendrimers can be used, for example polyamidoamine (PAMAM), e.g. STARBURST® dendrimers and polypropyleneimine (PPI), e.g. ASTRAMOL® dendrimers. Other types of dendrimers that are envisaged include phenylacetylene dendrimers, Frechet (i.e. poly(benzylether)) dendrimers, hyperbranched dendrimers and polylysine dendrimers. In one aspect of the invention a polyamidoamine (PAMAM) dendrimer is used.

Dendrimers include both metal-cored and organic-cored types, both of which can be employed in the present invention. Organic-cored dendrimers are generally preferred.

The properties of a dendrimer are influenced by its surface groups. In the present invention, the surface groups act as the binding point for attachment to the indicator, or where relevant, for separate attachment to the receptor and the fluorophore. Preferred surface groups therefore include functional groups which can be used in such binding reactions, for example amine groups, ester groups or hydroxyl groups, with amine groups being preferred. The nature of the surface group, however, is not particularly limited. Some conventional surface groups which could be envisaged for use in the present invention include amidoethanol, amidoethylethanolamine, hexylamide, sodium carboxylate, succinamic acid, trimethoxysilyl, tris(hydroxymethyl)amidomethane and carboxymethoxypyrrolidinone, in particular amidoethanol, amidoethylethanolamine and sodium carboxylate.

The number of surface groups on the dendrimer is influenced by the generation of the dendrimer. Preferably, the dendrimer has at least 4, more preferably at least 8 or at least 16 surface groups. Typically, in the complex of support bound indicator, all of the surface groups of the dendrimer will be bound to an indicator moiety. However, where some surface groups of the dendrimer remain unbound to an indicator moiety, the surface groups may be used to impart particular desired properties. For example, surface groups which enhance water-solubility such as hydroxyl, carboxylate, sulphate, phosphonate or polyhydroxyl groups may be present. Sulphate, phosphonate and polyhydroxyl groups are preferred examples of water soluble surface groups.

In one embodiment, the dendrimer incorporates at least one surface group which contains a polymerisable group. The polymerisable group may be any group capable of undergoing a polymerisation reaction, but is typically a carbon carbon double bond.

Examples of suitable surface groups incorporating polymerisable groups are amido ethanol groups wherein the nitrogen atom is substituted with a group of formula -linker-C═CH₂. The linker group is typically an alkylene, alkylene-arylene, or alkylene-arylene-alkylene group wherein the alkylene is typically a C1 or C2 alkylene group and arylene is typically phenylene. For example, the surface group may comprise an amidoethanol wherein the nitrogen atom is substituted with a —CH₂-Ph-CH═CH₂ group. The presence of a polymerisable group on the surface of the dendrimer enables the dendrimer to be attached to a polymer by polymerising the dendrimer with one or more monomers or polymers. Thus, the dendrimer can be tethered to, for example, a water soluble polymer in order to enhance water solubility of the dendrimer, or to a hydrogel (i.e. a highly hydrophilic cross-linked polymer matrix, e.g. of polyacrylamide) to assist in containing the dendrimer within the cell.

Preferably the dendrimer is symmetrical, i.e. all of the dendrons are identical.

In one aspect of the invention, the dendrimer for use in the present invention will have the general formula:

CORE-[A]ₙ

wherein CORE represents the metal or organic (preferably organic) core of the dendrimer and n is typically 4 or more, for example 8 or more, preferably 16 or more. Examples of suitable CORE groups include benzene rings and groups of formula —RN—(CH₂)ₚ—NR— and N—(CH₂)ₚ—N where p is from 2 to 4, e.g. 2 and R is hydrogen or a C1-C4 alkyl group, preferably hydrogen. —HN—(CH₂)₂—NH— and N—(CH₂)₂—N are preferred.

Each group A may be attached either to the CORE or to a further group A, thus forming the typical cascading structure of a dendrimer. In a preferred aspect, 2 or more, for example 4 or more, groups A are attached to the CORE (first generation groups A). The dendrimer is typically symmetrical, i.e. the CORE carries 2 or more, preferably 4 or more, identical dendrons.

Each group A is made up of a basic structure having one or more branching groups. The basic structure typically comprises alkylene or arylene moieties or a combination thereof. Preferably the basic structure is an alkylene moiety. Suitable alkylene moieties are C1-C6 alkylene moieties. Suitable arylene moieties are phenylene moieties. The alkylene and arylene moieties may be unsubstituted or substituted, preferably unsubstituted, and the alkylene moiety may be interrupted or terminated with a functional group selected from —NR′—, —O—, —CO—, —COO—, —CONR′—, —COO— and —OCONR′, wherein R′ is hydrogen or a C1-C4 alkyl group.

The branching groups are at least trivalent groups which are bonded to the basic structure and have two or more further points of attachment. Preferred branching groups include branched alkyl groups, nitrogen atoms and aryl or heteroaryl groups. Nitrogen atoms are preferred.

The branching groups are typically bonded to (i) the basic structure of the group A and (ii) to two or more further groups A. Where on the surface of the dendrimer, however, the branching group may itself terminate the dendrimer (i.e. the branching group is the surface group), or the branching group may be bonded to two or more surface groups. Examples of preferred groups A are groups of formula

—(CH₂)_{q}—(FG)ₛ-(CH₂)ᵣ—NH₂

wherein q and r are the same or different and represent an integer of from 1 to 4, preferably 1 or 2, more preferably 2. s is 0 or 1. FG represents a functional group selected from —NR′—, —O—, —CO—, —COO—, —CONR′—, —OCO— and —OCONR′, wherein R′ is hydrogen or a C1-C4 alkyl group. Preferred functional groups are —CONH—, —OCO— and —COO—, preferably —CONH—.

A discussed above, the surface group forms the point of attachment of the dendrimer to the indicator (or separately to the receptor and fluorophore moieties). The surface groups therefore typically include an unsubstituted or substituted alkylene or arylene moiety or a combination thereof, preferably an unsubstituted or substituted alkylene moiety, and at least one functional group which is suitable for bonding to the indicator. The functional group is typically an amine or hydroxyl group, with amine groups being preferred. Particular examples of surface groups are provided above.

Where the dendrimer employed is a metal-cored dendrimer, it may itself have fluorescent properties. In this case, it is envisaged that the dendrimer itself may form the fluorophore moiety. The supported indicator in this case simply comprises a receptor moiety bound to the dendrimer.

In a further embodiment of the invention, the support material is a non-dendritic, non-polymeric macromolecule having high molecular weight (i.e. at least 500, preferably at least 1000, 1500 or 2000). Cyclodextrins, cryptans and crown ethers are examples of such macromolecules. Such macromolecules also provide a uniform environment for the indicator and lead to a more consistent fluorophore response to analyte binding.

The indicator may be bonded to the support material by any appropriate means. Covalent linkages are preferred. Typically, the fluorophore and receptor are linked to form a fluorophore-receptor construct, which is then bound to the support material. Alternatively, the receptor and fluorophore may be separately bound to the support material. The number of indicator moieties per support material moiety is typically greater than 1, for example 4 or more, or 8 or more.

Where a polymeric support material is used, the indicator may be modified to include a double bond and copolymerised with a (meth)acrylate or other appropriate monomer to provide a polymer bound to the indicator. Alternative polymerisation reactions, or simple addition reactions, may also be employed. Wang et al (Wang B., Wang W., Gao S., (2001), Bioorganic Chemistry, 29, 308-320) provides an example of a polymerisation reaction including a monoboronic acid glucose receptor linked to an anthracene fluorophore.

In the case of a dendritic support material, the dendrimer is either reacted separately with the fluorophore and receptor moieties, or more preferably is reacted with a pre-formed receptor-fluorophore construct. Any appropriate binding reaction may be used. An example of a suitable technique is to react a dendrimer having surface amine groups with a fluorophore-receptor construct having a reactive aldehyde group by reductive amination in the presence of a borohydride type reagent. The resulting structure can be purified by ultrafiltration. An example of a dendrimer bound to a boronic acid receptor and an anthracene fluorophore is provided by James et al (Chem. Commum., 1996 p′706).

In the case of the dendritic support material having a polymerisable group as a surface group, the dendrimer may undergo a polymerisation reaction with one or more monomers in order to form a dendrimer-polymer construct wherein a polymer is bound to the surface of the dendrimer. Typically, the dendrimer is added at a late stage in the polymerisation reaction so that the dendrimer terminates the polymer chain.

Alternatively, the dendrimer may be reacted with a pre-formed polymer. This can be achieved, for example, by a condensation reaction between a carboxylic acid group on the polymer with a hydroxyl group on the dendrimer, to provide the link through the formed ester.

Examples of monomers and polymers which can be used in these reactions are (meth)acrylate, (meth)acrylamide and vinylpyrrolidone and combinations thereof and their corresponding polymers. Preferred polymers are water soluble polymers. Preferably, the water-solubility of the polymer is such that adequate fluorescent signal is produced when the polymer/indicator is dissolved in water (ideally infinite solubility). Polyacrylamide is particularly preferred since this leads to the formation of a highly water soluble polyacrylamide chain attached to the dendrimer. In one aspect of this embodiment, the polymer (e.g. polyacrylamide) chain bound to the dendritic support material is cross-linked to form a hydrogel. In this case, the dendrimer-hydrogel support material need not be in solution within the sensor. Optionally, the hydrogel has a high water content such that when placed in water there is no distinct interface between the aqueous phase and the polymer phase (as used herein, the hydrogel is in fluid form). In this case, it is typically provided in the form of a mixture with water or an aqueous solution.

Polymerisation from the surface of the dendrimer may be carried out either before or after attachment of the fluorophore and receptor moieties.

In the case of a sensor containing the indicator or supported indicator in solution, the concentration of indicator may be varied dependent on the required sensor properties. The higher the concentration or amount of indicator in the solution, the greater the signal level. Concentrations of 10⁻⁶ to 10⁻³M indicator, or supported indicator, have been found to be effective.

The sensor of the invention can be manufactured by providing a suitable optical waveguide, for example an optical fibre, which is adapted to direct incident light onto a cell containing the indicator. The cell may take any form as long as it is appropriate for containing the indicator in fluid form. In the case of an optical fibre sensor, typically, the cell can be produced by forming one or more holes in or near the tip of the fibre, for example by laser ablation. The indicator, or supported indicator, is dissolved in a suitable solvent, or otherwise provided in fluid form, and the fluid obtained is inserted into the cell. To maintain the indicator or supported indicator within the cell, any openings in the cell must be covered. One or more openings may be covered with an impermeable material if desired. One or more openings, however, are covered with an analyte permeable material to ensure that analyte will be able to enter the cell during use. This can be achieved, for example, by inserting the fibre into a sleeve of semi-permeable membrane. Alternatively, membrane can be separately attached across any openings in the cell.

Following its construction, the sensor must be stored in an appropriate environment which will enable the indicator or supported indicator to be maintained within the cell.

Typically, the sensor is stored such that the sensing region is immersed in water, or where a different solvent is used, the same solvent that is present within the cell.

### EXAMPLES

### Example 1

A polyacrylamide-bound indicator was prepared by dissolving the following components in 2.21 ml ethanol:

0.639 g acrylamide
0.0005 g Irgacure™ 651 (polymerisation initiator)
0.0032 g indicator (boronic acid glucose receptor linked to fluorophore).

The solution was degassed to remove all oxygen. UV light was then applied and the solution stirred until full precipitation occurred. The resulting polyacrylamide-bound indicator was washed with ethanol and dried

The polyacrylamide-bound indicator was dissolved in water at varying concentrations and inserted into an optical cell of a fibre optic sensor. A sleeve of cellulose-based dialysis membrane (Cuprofan) was placed over the sensing region of the fibre to contain the polyacrylamide-bound indicator. The sensor was found to be effective in detecting glucose using concentrations of polyacrylamide-bound indicator of from 10⁻⁶ to 10⁻³M.

The process can be employed using any boronic acid glucose receptor linked to a fluorophore, for example that described by Wang et al (referenced above).

### Example 2

### Synthesis of Receptor Moiety

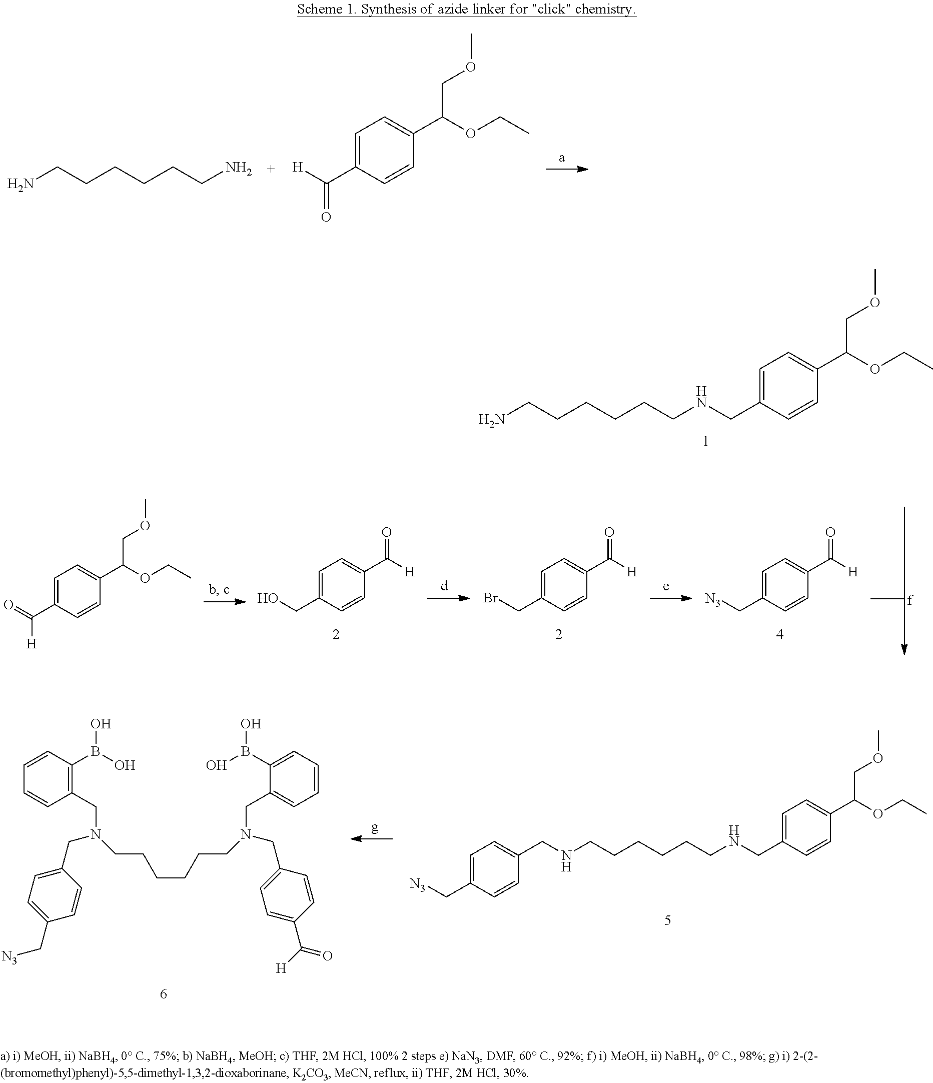

### N-(4-(Diethoxymethyl)benzyl)hexane-1,6-diamine, 1

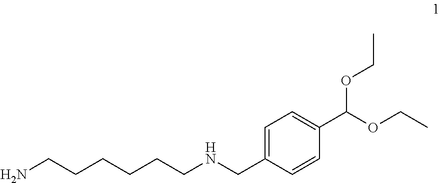 [SMILES: CCOC(OCC)c1ccc(CNCCCCCCN)cc1]

4-(Diethoxymethyl)benzaldehyde (5 ml, 25 mmol) was added slowly to hexane-1,6-diamine (14.5 g, 125 mmol, 5 eq) dissolved in methanol (100 ml) and stirred overnight. The reaction mixture was then cooled to 0° C. and NaBH₄ (1.89 g, 50 mmol, 2 eq) was then added slowly and the reaction mixture was stirred for 3 hours, after which the solvent was evaporated. The residue obtained was dissolved in ethyl acetate (100 ml) and water (100 ml), the phases were separated and the organic phase was washed with water (100 ml), dried over magnesium sulphate, and evaporated. The crude product was purified by flash chromatography (eluent DCM to DCM/methanol saturated with NH₃, 9:1) yielding 1 as a clear oil (5.73 g, 18.6 mmol, 75%). R_{f}=0.40 (9:1 DCM/MeOH saturated with NH₃); ¹H NMR (300 MHz, CDCl₃) δ=7.42 (d, ³J(H,H)=8.1 Hz, 2H, ArCH a to CHO₂), 7.30 (d, ³J(H,H)=8.1 Hz, 2H, ArCH a to CH₂NH), 5.49 (s, 1H, CHO₂), 3.78 (s, 2H, ArCCH₂), 3.61 (dq, ³J(H,H)=7.1 Hz, ²J(H,H)=9.5 Hz, 2H, CH₂CH₃), 3.53 (dq, ³J(H,H)=7.1 Hz, ²J(H,H)=9.5 Hz, 2H, CH₂CH₃), 2.67 (t, ³J(H,H)=6.9 Hz, 2H, CH₂CH₂NH₂), 2.61 (t, ³J(H,H)=7.2 Hz, 2H, CH₂CH₂NH), 1.55-1.30 (m, 8H, CH₂) 1.24 (bs, 2H, NH₂), 1.23 (t, ³J(H,H)=7.1 Hz, 6H, CH₂CH₃); ¹³C NMR (75 MHz, CDCl₃) δ=140.6 (ArCCH₂NH), 137.7 (ArCCHO₂), 127.9 (ArCH a to CH₂NH), 126.6 (ArCH a to CHO₂), 101.5 (CHO₂), 61.0 (OCH₂CH₃), 53.8 (ArCCH₂), 49.4 (CH₂CH₂NH), 42.2 (CH₂CH₂NH₂), 33.8 (CH₂), 30.1 (CH₂), 27.2 (CH₂), 26.8 (CH₂), 15.2 (OCH₂CH₃); HRMS (ESI⁺): m/z calculated for C₁₈H₃₃N₂O₂ [M+H]⁺: 309.2537, found 309.2527.

### 4-(Diethoxymethyl)benzyaldehyde, 2

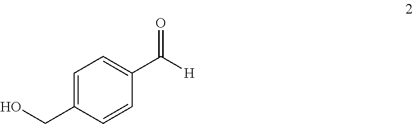

4-(Diethoxymethyl)benzaldehyde (10 g, 48 mmol) was dissolved in methanol (200 ml) and cooled to 0° C. NaBH₄ (4.54 g, 120 mmol, 2.5 eq) was then added slowly and the reaction mixture was stirred for 1 hour, after which the solvent was evaporated. The residue obtained was dissolved in ethyl acetate (100 ml) and water (100 ml), the phases were separated and the organic phase was washed with water (100 ml), dried over magnesium sulphate, and evaporated to yield a clear oil. The oil was dissolved in a mixture of THF (100 ml) and 2 M HCl (100 ml) and stirred for 1 hour. The solvent was evaporated and the residue obtained was dissolved in ethyl acetate (100 ml) and water (100 ml). The phases were separated and the organic phase was washed with water (100 ml), dried over magnesium sulphate, and evaporated to yield the product as a white solid (6.54 g, 48 mmol, 100%). R₁=0.54 (ethyl acetate/chloroform, 1:1); m.p.=42° C. (from distillate); ¹H NMR (250 MHz, CDCl₃) δ=10.02 (s, 1H, CHO), 7.89 (d, ³J(H,H)=8.1 Hz, 2H, ArCH a to CHO), 7.54 (d, ³J(H,H)=8.1 Hz, 2H, ArCH a to CH₂OH), 4.82 (d, ³J(H,H)=5.9 Hz, 2H, CH₂OH), 1.94 (t, ³J(H,H)=5.9 Hz, 1H, CH₂OH); ¹³C NMR (75 MHz, CDCl₃) δ=192.0 (CHO), 147.7 (ArCCOH), 135.7 (ArCCHO), 130.0 (ArCH a to ArCCHO), 127.0 (ArCH a to ArCCH₂OH), 64.6 (CH₂OH); HRMS (PSI): m/z calculated for C₈H₇O₂ [M−H]⁻: 135.0446. found 135.0448; elemental analysis calcd (%) for C₈H₈O₂ (136.15): C 70.57, H 5.92. found: C 70.70, H 6.00.

### 4-(Bromomethyl)benzaldehyde, 3

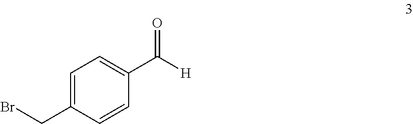

4-(Hydroxymethyl)benzaldehyde 2 (6.19 g, 45.5) was dissolved in DCM (50 ml) before HBr in acetic acid (25 ml) was added and stirred overnight. The residue was purified by flash chromatography (eluent hexane/ethyl acetate, 9:1) yielding 3 as a white solid (6.60 g, 33.2 mmol, 73%). R_{f}=0.77 (DCM); m.p.=100° C. (recrystallised from hexane); νₘₐₓ=1682, 1604, 1209, 1200, 830, 770, 726 cm⁻¹; ¹H NMR (300 MHz, CDCl₃) δ=10.02 (s, 1H, CHO), 7.87 (d, ³J(H,H)=8.2 Hz, 2H, ArCH a to CHO), 7.56 (d, ³J(H,H)=8.2 Hz, 2H, ArCH a to CH₂Br), 4.52 (s, 2H, CH₂Br); ¹³C NMR (75 MHz, CDCl₃) δ=191.5 (CHO), 144.2 (ArCCBr), 136.2 (ArCCHO), 130.2 (ArCH a to ArCCHO), 129.7 (ArCH a to ArCCH₂Br), 31.9 (CH₂Br); FIRMS m/z calculated for C₈H₆BrO [M−H]⁻: 196.9602. found 196.9602; elemental analysis calcd (%) for C₈H₇BrO (199.04): C 48.27, H 3.54. found: C 47.40, H 3.53.

### 4-(Azidomethyl)benzaldehyde, 4

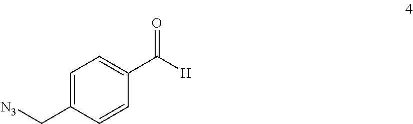 [SMILES: [N-]=[N+]=NCc1ccc(C=O)cc1]

4-(Bromomethyl)benzaldehyde 3 (180 mg, 0.90 mmol) was dissolved in DMF (10 ml). Sodium azide (88 mg, 1.35 mmol) was added. The reaction mixture was then heated at 60° C. for an hour. The reaction mixture was allowed to cool and was dissolve in DCM (150 ml) and H₂O (150 ml). The phases were separated and the organic phase was washed again with water (2×150 ml). The organic phase was dried over sodium sulphate, and evaporated under reduced pressure to yield 4 as an oil (134 mg, 0.83 mmol, 92%). R_{f}=0.70 (DCM); νₘₐₓ=2094, 1694, 1607, 1207, 1167, 812, 773 cm⁻¹; ¹H NMR (300 MHz, CDCl₃) δ=10.02 (s, 1H, CHO), 7.90 (d, ³J(H,H)=7.9 Hz, 2H, ArCH a to CHO), 7.48 (d, ³J(H,H)=7.9 Hz, 2H, ArCH a to CH₂N₃), 4.45 (s, 2H, CH₂N₃); ¹³C NMR (75 MHz, CDCl₃) δ=191.6 (CHO), 142.1 (ArCCH₂N₃), 136.2 (ArCCHO), 130.2 (ArCH a to ArCCHO), 128.4 (ArCH a to ArCCH₂N₃), 54.2 (CH₂N₃); HRMS (ESI⁺): m/z calculated for C₈H₇N₃ONa [M+Na]⁺: 184.0481. found 184.0497.

### N-(4-(azidomethyl)benzyl)-N′-(4-(diethoxymethyl)benzyl)-hexane-1,6-diamine, 5

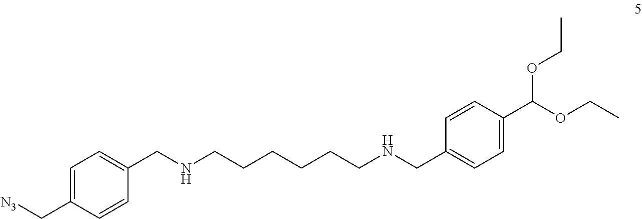 [SMILES: CCOC(OCC)c1ccc(CNCCCCCCNCc2ccc(CN=[N+]=[N-])cc2)cc1]

4-(Azidomethyl)benzaldehyde 4 (1.30 g, 8.1 mmol) was added to M-(4-(diethoxymethyl)benzyl)hexane-1,6-diamine 1 (2.5 g, 8.2 mmol, 1.01 eq) dissolved in methanol (40 ml) and stirred overnight. The reaction mixture was then cooled to 0° C. and NaBH₄ (0.76 g, 20.2 mmol, 2.5 eq) was then added slowly and the reaction mixture was stirred for 3 hours, after which the solvent was evaporated. The residue obtained was dissolved in ethyl acetate (100 ml) and water (100 ml), the phases were separated and the organic phase was washed with water (100 ml), dried over magnesium sulphate, and evaporated. The crude product was purified by flash chromatography (eluent DCM to DCM/methanol saturated with NH₃, 19:1) yielding 5 as a clear oil (3.60 g, 7.9 mmol, 98%). R_{f}=0.73 (9:1 DCM/MeOH saturated with NH₃); ¹H NMR (300 MHz, CDCl₃) δ=7.42 (d, ³J(H,H)=8.1 Hz, 2H, ArCH), 7.36-7.26 (m, 6H, ArCH), 5.50 (s, 1H, CHO₂), 4.32 (s, 2H, CH₂N₃), 3.79 (s, 2H, ArCCH₂), 3.78 (s, 2H, ArCCH₂), 3.61 (dq, ³J(H,H)=7.1 Hz, ²J(H,H)=9.5 Hz, 2H, CH₂CH₃), 3.52 (dq, ³J(H,H)=7.1 Hz, ²J(H,H)=9.5 Hz, 2H, CH₂CH₃), 2.62 (t, ³J(H,H)=7.1 Hz, 2H, CH₂CH₂NH₂), 2.62 (t, ³J(H,H)=7.1 Hz, 2H, CH₂CH₂NH₂), 1.55-1.45 (m, 4H, CH₂) 1.40-1.30 (m, 4H, CH₂), 1.24 (t, ³J(H,H)=7.1 Hz, 6H, CH₂CH₃); ¹³C NMR (75 MHz, CDCl₃) δ=140.9 (ArCCH₂NH), 140.7 (ArCCH₂NH), 137.7 (ArCCHO₂), 133.9 (ArCCH₂N₃), 128.5 (ArCH), 128.3 (ArCH), 127.9 (ArCH), 126.7 (ArCH), 101.5 (CHO₂), 61.0 (OCH₂CH₃), 54.6 (CH₂N₃), 53.8 (ArCCH₂), 53.7 (ArCCH₂), 49.4 (CH₂CH₂NH), 49.4 (CH₂CH₂NH), 30.0 (CH₂), 27.3 (CH₂), 15.2 (OCH₂CH₃); HRMS (ESI⁺): m/z calculated for C₂₆H₄₀N₅O₂ [M+H]⁺: 454.3177. found 454.3182.

### Azido aldehyde with bisboronic acid, 6

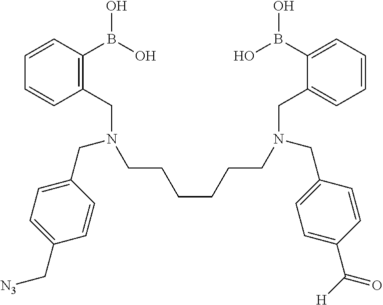 [SMILES: [N-]=[N+]=NCc1ccc(CN(CCCCCCN(Cc2ccc(C=O)cc2)Cc2ccccc2B(O)O)Cc2ccccc2B(O)O)cc1]

N-(4-(azidomethyl)benzyl)-N′-(4-(diethoxymethyl)benzyl)-hexane-1,6-diamine 5 (250 mg, 0.59 mmol), 2-(2-(bromomethyl)phenyl)-5,5-dimethyl-1,3,2-dioxaborinane (D. K. Scrafton, J. E. Taylor, M. F. Mahon, J. S. Fossey and T. D. James, J. Org. Chem., 2008, 73, 2871-2874) (419 mg, 1.41 mmol, 2.4 eq), and K₂CO₃ (324 mg, 2.34 mmol, 4 eq) were dissolved in dry acetonitrile (50 ml) under a nitrogen environment and heated at reflux for 6 hours. The solvent was evaporated and the residue obtained was dissolved in ethyl acetate (50 ml) and water (50 ml), the phases were separated and the organic phase was washed with water (50 ml), dried over magnesium sulphate, and evaporated. The solid obtained was dissolved in THF and 2 M HCl (100 ml) and stirred for 1 hour, after which the solvent was evaporated. The residue obtained was dissolved in ethyl acetate (50 ml) and water (50 ml), the phases were separated and the organic phase was washed with water (100 ml), dried over magnesium sulphate, and evaporated. The crude product was purified by flash chromatography (DCM to MeOH to MeOH sat. NH₃) yielding the product as a white solid (110 mg, 0.17 mmol, 30%). R_{f}=0.45 (9:1 DCM/MeOH saturated with NH₃); ¹H NMR (300 MHz, CDCl₃/CD₃OD 95:5) δ=9.97 (s, 1H, CHO), 7.83 (d, ³J(H,H)=Hz, 4H, ArCH), 7.42 (d, ³J(H,H)=Hz, 2H, ArCH), 7.27-7.35 (m, 8H, ArCH), 7.18 (bs, 2H, ArCH), 4.32 (s, 2H, CH₂N₃), 3.74 (s, 2H, CH₂), 3.73 (s, 2H, CH₂), 3.62 (s, 2H, CH₂), 3.58 (s, 2H, CH₂), 2.38 (bs, 4H, CH₂CH₂N), 1.47 (bs, 4H, CH₂CH₂N), 1.05 (bs, 4H, CH₂CH₂CH₂N); ¹¹B NMR (96 MHz, CDCl₃/CD₃OD 95:5) δ=34.6; ¹³C NMR (75 MHz, CDCl₃/CD₃OD 95:5) δ=192.2 (CHO), 144.1 (ArC), 141.3 (ArC), 141.1 (ArC), 136.6 (ArC), 135.4 (ArC), 134.5 (ArC), 129.9 (ArCH), 129.8 (ArCH), 128.2 (ArCH), 127.3 (ArCH), 127.2 (ArCH), 61.2 (ArCCH₂N), 61.0 (ArCCH₂N), 57.0 (ArCCH₂N), 56.6 (ArCCH₂N), 54.3 (CH₂N₃), 52.7 (CH₂CH₂N), 52.0 (CH₂CH₂N), 26.9 (CH₂CH₂CH₂N), 24.6 (CH₂CH₂N), 24.5 (CH₂CH₂N); HRMS (EST⁺): m/z calculated for C₃₆H₄₂B₂N₅O₄ (anhydride) [M+H—H₂O]⁺: 630.3417. found 630.3382.

### Fluorophore

Receptor 6 as produced in accordance with the synthesis above is bound to a fluorophore by reaction with the aldehyde group. This can be achieved by reductive amination of the amine group on the fluorophore in the presence of a borohydride type reagent. Suitable fluorophores include anthracene or pyrene or derivatives thereof.

### Dendrimers

PAMAM dendrimers of generation 1 or 2 are synthesised in accordance with Cheng et al (European Journal of Medicinal Chemistry, 2005, 40, 1384-1389). The dendrimers produced are depicted below.

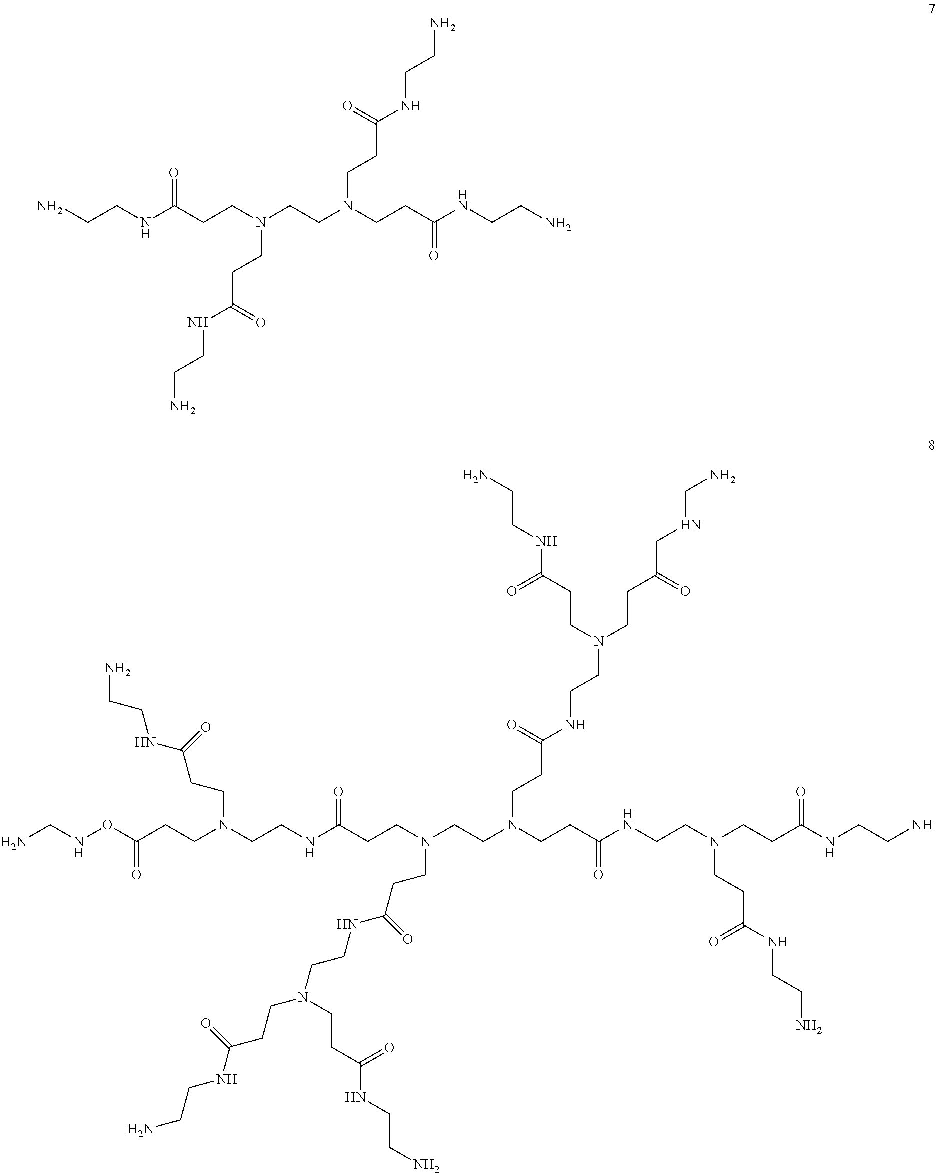 [SMILES: NCCNC(=O)CCN(CCC(=O)NCCN)CCN(CCC(=O)NCCN)CCC(=O)NCCN ; NCCNC(=O)CCN(CCNC(=O)CCN(CCC(=O)NCCN(CCC(=O)NCCN)CCC(=O)NCCN)CCN(CCC(=O)NCCN(CCC(=O)NCCN)CCC(=O)NCCN)CCC(=O)NCCN(CCC(=O)NCCN)CCC(=O)ONCN)CCC(=O)CNCN]

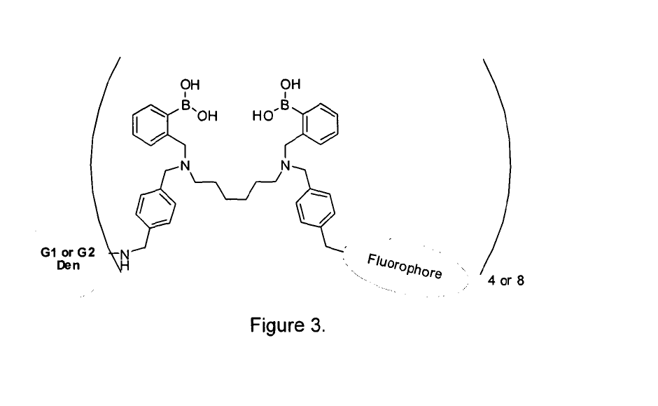

The generation 1 or 2 dendrimers are coupled to receptor 5 by reaction with the aldehyde group to yield a dendrimer with either 4 or 8 receptors appended. Attachment of the dendrimer to receptor 6 may be carried out either before or after linking with the fluorophore. FIG. 3 depicts the generation 1 or generation 2 dendrimer with either 4 or 8 receptors (prior to fluorophore binding) appended thereto.

### Example 3

Dendrimers were synthesised according to the following procedure. These are bound to receptor 6 (before or after binding to fluorophore) as described in Example 2.

### Dendrimer Synthesis

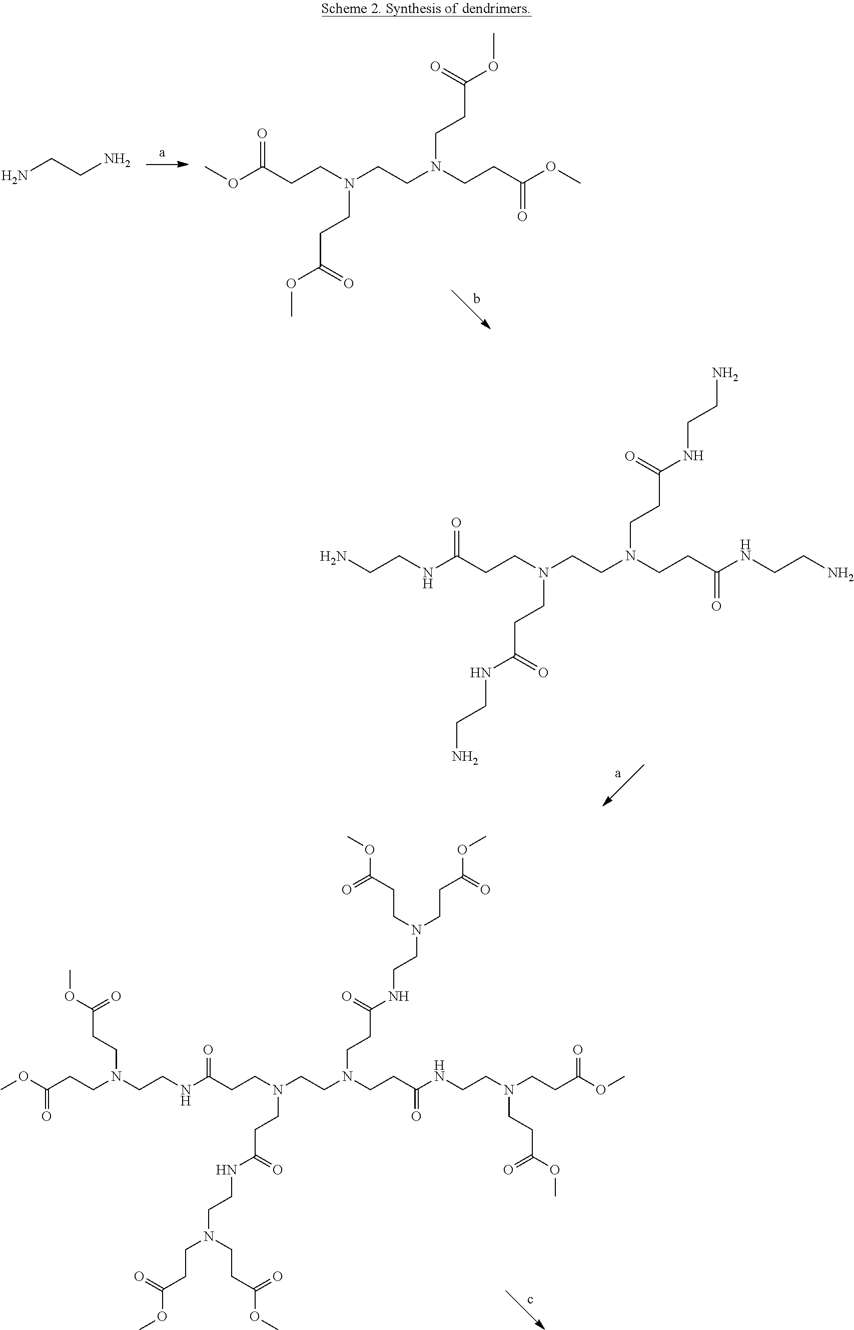

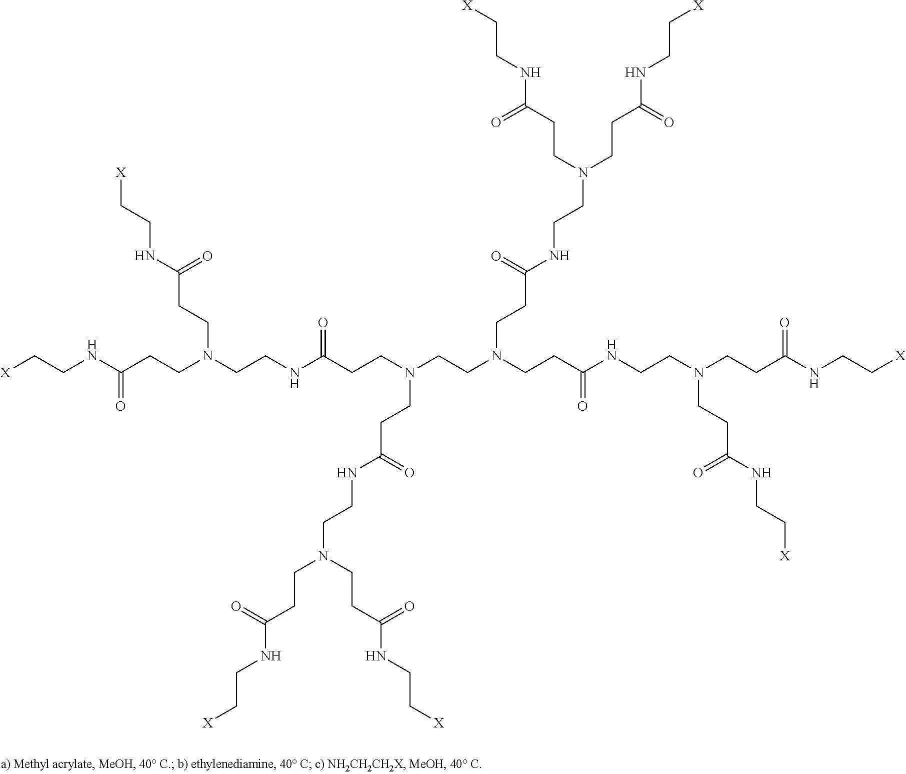

### 2-Azidoethanamine

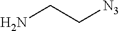

¹H NMR (300 MHz, CDCl₃) δ=3.38 (t, ³J(H,H)=5.7 Hz, 2H, CH₂N₃), 2.88 (t, ³J(H,H)=5.7 Hz, 2H, CH₂NH₂); ¹³C NMR (75 MHz, CDCl₃) δ=54.6 (CH₂N₃), 41.3 (CH₂NH₂); HRMS (ESI⁺): m/z calculated for C₂H₇N₄ [M+H]⁺: 87.0665. found 87.0663.

### G0.5

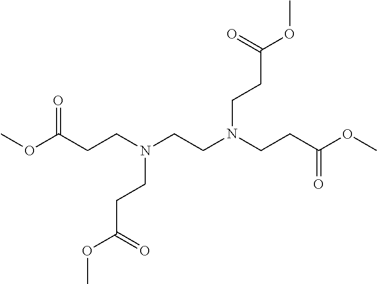

### Yellow oil.

¹H NMR (300 MHz, CDCl₃) δ=3.66 (s, 12H, OCH₃), 2.76 (t, ³J(H,H)=7.0 Hz, 8H, NCH₂CH₂CO), 2.49 (NCH₂CH₂N), 2.43 (t, ³J(H,H)=7.0 Hz, 8H, NCH₂CH₂CO); ¹³C NMR (75 MHz, CDCl₃) δ=172.9 (CO), 52.2 (NCH₂CH₂N), 51.5 (OCH₃), 49.7 (NCH₂CH₂CO), 32.6 (NCH₂CH₂CO).

### G1

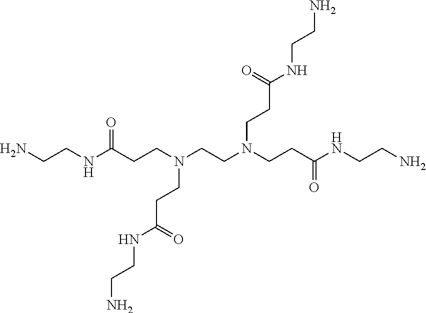 [SMILES: NCCNC(=O)CCN(CCC(=O)NCCN)CCN(CCC(=O)NCCN)CCC(=O)NCCN]

¹H NMR (300 MHz, CDCl₃) δ=3.66 (s, 12H, OCH₃), 2.76 (t, ³J(H,H)=7.0 Hz, 8H, NCH₂CH₂CO), 2.49 (NCH₂CH₂N), 2.43 (t, ³J(H,H)=7.0 Hz, 8H, NCH₂CH₂CO); ¹³C NMR (75 MHz, CDCl₃) δ=172.9 (CO), 52.2 (NCH₂CH₂N), 51.5 (OCH₃), 49.7 (NCH₂CH₂CO), 32.6 (NCH₂CH₂CO); HRMS (EV): m/z calculated for C₂₂H₄₈N₁₀O₄Na [M+Na]⁺: 539.3752. found 539.3752.

### G1 Azide

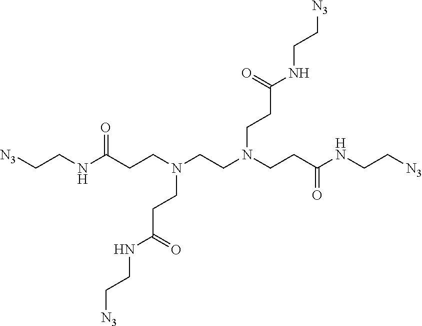 [SMILES: [N-]=[N+]=NCCNC(=O)CCN(CCC(=O)NCCN=[N+]=[N-])CCN(CCC(=O)NCCN=[N+]=[N-])CCC(=O)NCCN=[N+]=[N-]]

Reaction didn't go to completion.

¹H NMR (300 MHz, CDCl₃) δ=3.66 (s, 12H, OCH₃), 2.76 (t, ³J(H,H)=7.0 Hz, 8H, NCH₂CH₂CO), 2.49 (NCH₂CH₂N), 2.43 (t, ³J(H,H)=7.0 Hz, 8H, NCH₂CH₂CO); ¹³C NMR (75 MHz, CDCl₃) δ=172.9 (CO), 52.2 (NCH₂CH₂N), 51.5 (OCH₃), 49.7 (NCH₂CH₂CO), 32.6 (NCH₂CH₂CO).

### G1.5

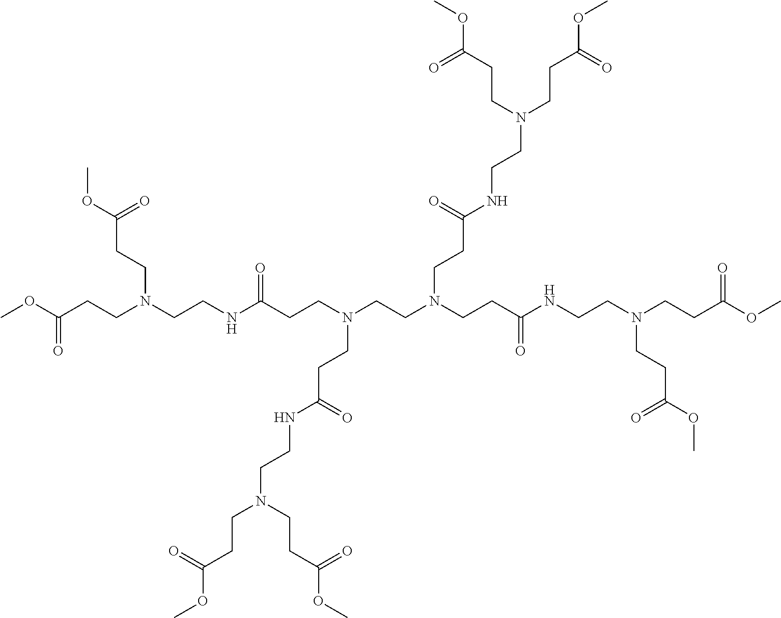

¹H NMR (300 MHz, CDCl₃) δ=3.66 (s, 12H, OCH₃), 2.76 (t, ³J(H,H)=7.0 Hz, 8H, NCH₂CH₂CO), 2.49 (NCH₂CH₂N), 2.43 (t, ³J(H,H)=7.0 Hz, 8H, NCH₂CH₂CO); ¹³C NMR (75 MHz, CDCl₃) δ=172.9 (CO), 52.2 (NCH₂CH₂N), 51.5 (OCH₃), 49.7 (NCH₂CH₂CO), 32.6 (NCH₂CH₂CO); HRMS (ESI⁺): m/z calculated for C₅₄H₉₇N₁₀O₂₀ [M+H]⁺: 1205.6875. found 1205.6898.

### G2.0

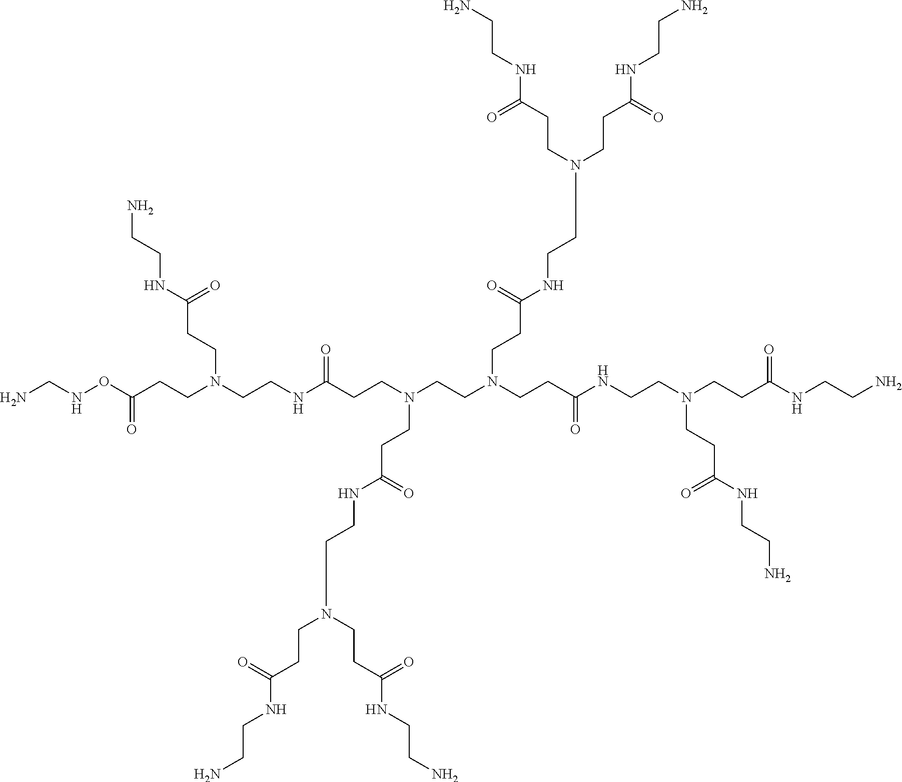 [SMILES: NCCNC(=O)CCN(CCNC(=O)CCN(CCC(=O)NCCN(CCC(=O)NCCN)CCC(=O)NCCN)CCN(CCC(=O)NCCN(CCC(=O)NCCN)CCC(=O)NCCN)CCC(=O)NCCN(CCC(=O)NCCN)CCC(=O)ONCN)CCC(=O)NCCN]

¹H NMR (300 MHz, CDCl₃) δ=3.66 (s, 12H, OCH₃), 2.76 (t, ³J(H,H)=7.0 Hz, 8H, NCH₂CH₂CO), 2.49 (NCH₂CH₂N), 2.43 (t, ³J(H,H)=7.0 Hz, 8H, NCH₂CH₂CO); ¹³C NMR (75 MHz, CDCl₃) δ=172.9 (CO), 52.2 (NCH₂CH₂N), 51.5 (OCH₃), 49.7 (NCH₂CH₂CO), 32.6 (NCH₂CH₂CO).

The present invention has been described with reference to particular embodiments and examples, but it is to be understood that the invention is not limited to these embodiments and examples.

1. An optical sensor for determining the amount or presence of an analyte in a medium, the sensor comprising a cell comprising (a) an indicator for the analyte or (b) a supported indicator comprising an indicator for the analyte bonded to a support material, wherein the indicator or supported indicator is in fluid form, and wherein the cell comprises one or more openings covered with an analyte-permeable membrane, the membrane being adapted to retain the indicator or supported indicator within the cell.

2. A sensor according to claim 1, wherein the cell comprises a solution of the indicator or supported indicator.

3. A sensor according to claim 2, wherein the cell comprises a supported indicator wherein the support material is a dendrimer.

4. A sensor according to claim 3, wherein the dendrimer is a polyamidoamine dendrimer.

5. A sensor according to claim 3, wherein the dendrimer is bound to at least 4 indicator moieties.

6. A sensor according to claim 3, wherein the dendrimer is symmetrical.

7. A sensor according to claim 3, wherein the dendrimer is bound to a water-soluble polymer.

8. A sensor according to claim 1, wherein the cell contains a fluid mixture comprising (i) water or an aqueous solution and (ii) a supported indicator, wherein the support material is a hydrogel having water dispersed therein, said hydrogel having water dispersed therein being in the form of a fluid.

9. A sensor according to claim 8, wherein the hydrogel has a water content of at least 30% w/w.

10. A sensor according to claim 1, wherein the indicator comprises a receptor and fluorophore and wherein the receptor and the fluorophore are separately bonded to a support material.

11. A sensor according to claim 1, wherein the analyte is glucose and the indicator comprises a receptor moiety having one or more boronic acid groups.

12. A sensor according to claim 1 wherein the sensor is adapted to monitor the fluorescence intensity of the fluorophore.

13. A sensor according to claim 1 wherein the sensor is adapted to monitor the fluorescence lifetime of the fluorophore.

14. A kit comprising a sensor according to claim 1, apparatus adapted to supply incident light to the optical waveguide, and a detector for detecting a returned signal.

15. A method of manufacturing an optical sensor according to claim 1, comprising providing a cell having one or more openings, inserting into the cell (a) an indicator or (b) a supported indicator comprising an indicator bonded to a support material, wherein the indicator or supported indicator is in fluid form, and covering one or more openings of the cell with an analyte-permeable membrane, the membrane being adapted to retain the indicator or supported indicator within the cell.

16. A method of determining the presence or concentration of an analyte in a medium, the method comprising providing incident light to the cell of an optical sensor as defined in claim 1 and detecting a return optical signal.

17. A method according to claim 16, wherein the indicator comprises a fluorophore and wherein the method comprises measuring the fluorescence intensity of the fluorophore.

18. A method according to claim 16, wherein the indicator comprises a fluorophore and wherein the method comprises measuring the fluorescence lifetime of the fluorophore.
